(19) United States
(12) Patent Application Publication
(10) Pub. No.: US 2005/0252989 A1
(43) Pub. Date: Nov. 17, 2005

(54) Water driven fire hose spinning nozzle

(76) Inventor: Richard A. Carpenter, Freehold, NJ (US)

Correspondence Address: Charles I. Brodsky, 2 Bucks Lane, Marlboro, NJ, 07746, US

(21) Appl. No.: 11/122,649

(22) Filed: May 5, 2005

Related U.S. Application Data
(60) Provisional application No. 60/570,063, filed on May 12, 2004.

(51) Int. Cl. A62C 2/00

(52) U.S. Cl. 239/271; 169/70

(57) ABSTRACT

A nozzle design for a fire extinguisher composed of two stages, the first of which includes a water driven auger bit capable of drilling through a burning structure followed by a second rotating nozzle tip stage to spray water in a circular motion so as to limit and extinguish further spread of fire.

### CROSS-REFERENCE TO RELATED APPLICATIONS

A provisional application describing this invention was filed May 12, 2004 and assigned Ser. No. 60/570,063.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

1. Field of the Invention

This invention relates to the field of firematics, in general, and to firefighting in an enclosed environment, in particular.

2. Description of the Related Art

As is understood, current firefighting procedures for fighting attic, basement and room fires involve employing two firefighters using such entry tools as an ax or saw, along with a fire hose all of which are very heavy and cumbersome. As is also well known, entry into a burning attic is often made from the roof, and sometimes from the floor below. Entry into rooms or basements is generally from the inside.

While this type of firefighting puts a firefighter in danger of smoke inhalation, flashover and backdraft, working in an attic presents the added danger of roof and ceiling collapse.

### OBJECTS OF THE INVENTION

It is an object of the present invention to provide new and improved firefighting apparatus especially useful in dealing with a fire in an enclosed structure.

It is an object of the present invention, also, to provide such firefighting apparatus which can be utilized from outside a structure while combating a fire within.

It is a further object of the invention to provide such firefighting apparatus which could be utilized by a firefighter with a high degree of safety.

### SUMMARY OF THE INVENTION

The present invention encompasses a nozzle design which provides a safer, more effective procedure to fight fires in wood structured buildings. Utilizing a water driven, spinning nozzle, the firefighter is able to drill through a structure, ventilate it, and subsequently mount the nozzle in a roof, wall or floor. This enables the firefighter to feed a water curtain into the area where a fire could be burning (or is actually burning) with a significantly reduced risk. Once so mounted, the nozzle could be left in place to extinguish the fire, with water pressure being adjustable from appropriate fire apparatus outside the structure. In other words, once the nozzle is so mounted, the firefighter can leave the hazardous area, and to return at a later time. This is particularly important in a “barn fire”, for instance, or just in a residential dwelling where a sprinkler system is not in place and further spread of fire must be stopped.

### BRIEF DESCRIPTION OF THE DRAWINGS

These and other features of the invention will be more clearly understood from a consideration of the following description, taken in connection with the accompanying drawings, in which:

FIGS. 1 and 2 illustrate the water driven fire hose spinning nozzle of the invention as it might be employed in fighting an attic fire from a roof.

### DETAILED DESCRIPTION OF THE INVENTION

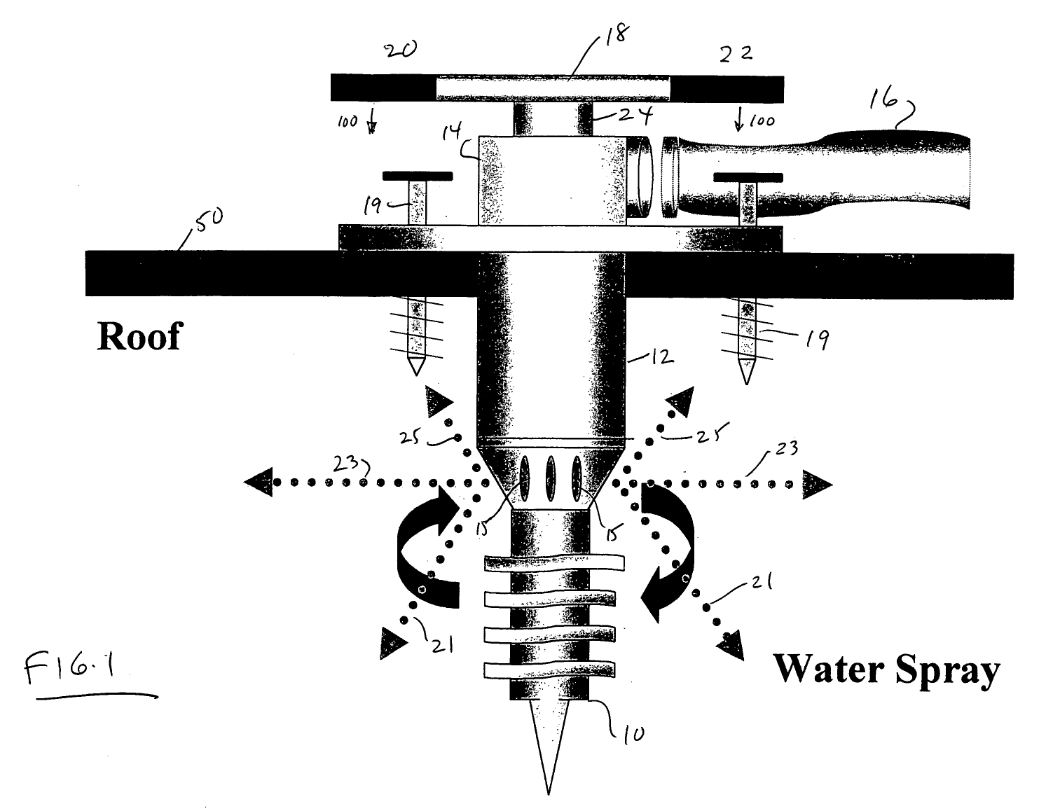

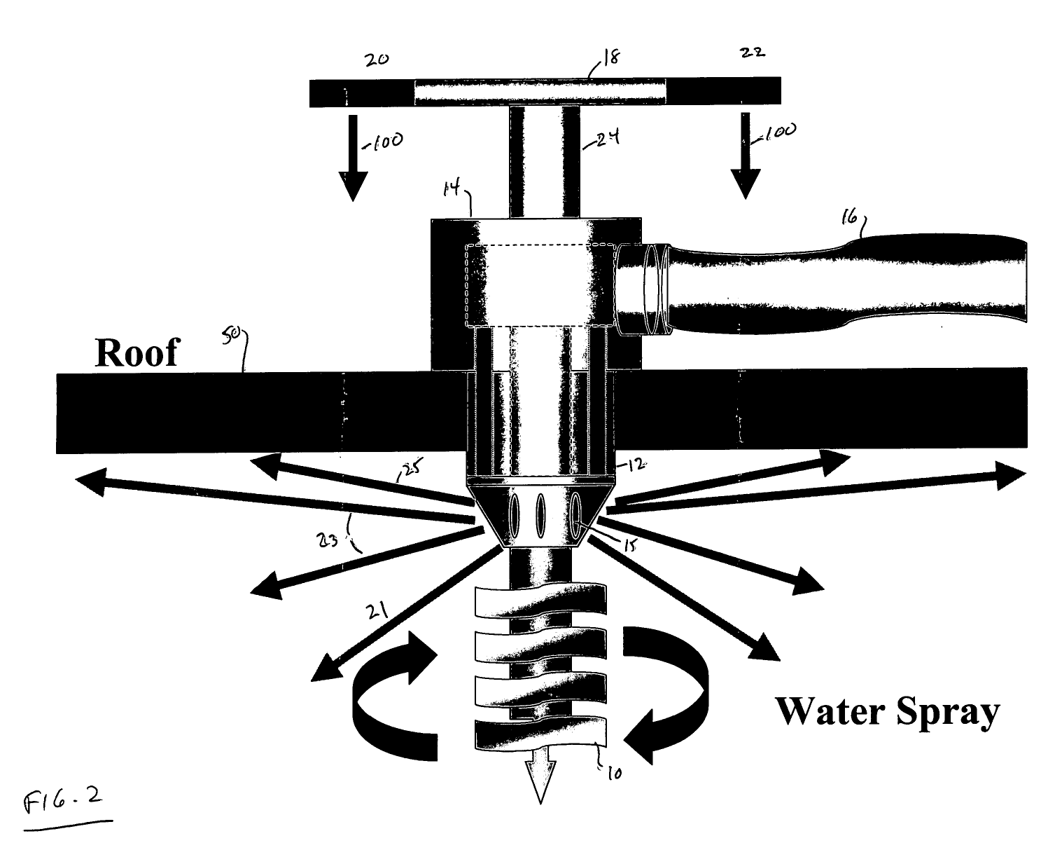

As will be seen from FIG. 1, the nozzle design of the invention essentially consists of two parts. The first is a water driven auger bit used to drill through the burning structure, while the second is a rotating nozzle tip that follows to spray water in a circular motion. Such spraying completely saturates the voided area, thereby extinguishing further spread of the fire.

More specifically, reference numeral 10 in FIG. 1 represents an auger drill bit coupled with a following rotating spray nozzle 12 outwardly extending from a housing 14 having an input port coupled with a high pressure fire hose shown at 16. A handle 18, graspable at 20, 22 is joined with the housing 14 through any appropriate linkage 24 to provide the housing 14, the rotating nozzle 12 and the auger bit 10 with a downward force as shown at 100. With the firefighter standing on a roof 50, water supplied at an adjustable pressure from the fire truck apparatus flows through the hose 16 to rotate the nozzle 12 and bit 10 so as to force the two together through the roof 50. With a molly or similar-lock arrangement 19, the housing 14 can be temporarily secured to the roof 50, enabling the firefighter to leave the site, and the water pressure at the fire truck adjusted to control an outward water spray from the nozzle by means of its ports 15. Such ports 15 may be oriented and aligned to provide a downward directed spray as at 21, an outward spray as at 23, and an upward spray as at 25, directed toward the underside of the roof 50. In such manner, the fire truck operator, who is also safely outside the structure, can control the volume of water and its ability to extinguish the fire. Even if the fire could not in this manner be completely extinguished, a “water curtain” would now be in place preventing the fire from passing through the roof and burning the rest of the structure. In such manner, the auger bit 10 continues to spin because of the water pressure, rotating the seated nozzle to spray water in all directions.

As will be appreciated by those skilled in the art, the apparatus of the invention could also be used to drill through a wall in controlling a fire in an adjacent room. Additionally, if there were a possibility of flashover or backdraft were a door to be opened in a raging fire, the drill bit 10 could be pointed to drill through a door or wall allowing the spray to stream past on the other side. Both in this use, as well as in dealing with an attic fire, the firefighter would be protected by being able to leave the hazardous area until the fire had died down to a safe level. Then, the firefighter can easily unseat the housing 14 to free the water driven nozzle for similar use at another location where a roof or wall needs to be driven through to allow the firefighter to exert his/her skill in a controllable, safe manner. And, in those instances where available water pressure might not be sufficient to operate the nozzle, the nozzle itself might be driven into the roof or wall manually before attaching the hose to complete the installation.

As will be understood, then, with the apparatus of the invention, a firefighter no longer has to fight a fire in an attic or room from on a roof or from inside the building. The nozzle design of the invention allows the apparatus to be drilled through the roof or wall, and be water driven by a volume of water which can be adjusted at the fire truck itself. As the drill bit comes through the structure, the nozzle follows it and is seated into the wood where it is anchored. Analysis has shown that with the spinning nozzle of the invention, an entire room or a large portion of an attic then in flame can be extinguished simply by the operator of the fire truck who stays safely outside the structure. With the drill and nozzle spinning, and with the nozzle adjusted to provided either a straight stream through to a fog pattern, the outlets of water could be pointed up, straight out, down, or straight down as the nozzle spins, acting to extinguish the fire in all directions.

Especially in dealing with roof fires, where the fire comes up to the bottom of the roof and starts burning up towards the peak, the water driven fire hose spinning nozzle of the invention is able to expel the water not only back up towards the roof, but downwardly to put out the fire that is below. In an attic, the spinning in all directions then puts out a water curtain; with a barn fire, a large water curtain is produced inside, to extinguish the fire within.

While there have been described what is considered to be a preferred embodiment of the present invention, it will be readily understood by those skilled in the art that modifications can be made without departing from the scope of the teachings herein of being able, with the water driven spinning nozzle, not having to continuously try to maneuver and drag a heavy hose about, but instead anchoring the nozzle onto a roof or wall and leaving it there while operating in protecting the firefighter. For at least such reason, therefore, resort should be had to the claims appended hereto for a true understanding of the invention.

1. In a fire extinguisher, apparatus comprising:
an auger drill bit having first and second opposing ends;
a housing including a rotatable spray nozzle coupled with said first end of said drill bit;
means on said housing for coupling to a source of externally supplied water;
and a handle on said housing for applying a downward force thereto;
whereby supplying said water under pressure rotates said drill bit to force said second end thereof through one of a wall, floor and ceiling surface while rotating said nozzle to spray a stream of water thereat in the extinguishment of a fire being present.

2. The apparatus of claim 1 wherein said rotatable spray nozzle includes a plurality of ports, individual ones of which are configured to spray water out from said housing.

3. The apparatus of claim 1 wherein said rotatable spray nozzle-includes a plurality of ports, individual ones of which are configured to spray water upwardly, downwardly, and outwardly out from said housing.

4. The apparatus of claim 3, also including means cooperating with said housing for securing said housing in place at said wall, floor and ceiling surface as said spray nozzle and drill bit rotate in response to the water being externally supplied.

5. In a fire extinguisher, apparatus comprising:
an auger drill bit having first and second opposing ends;
a housing including a rotatable spray nozzle coupled with said first end of said drill bit;
a fire hose coupled at one end to said housing and to a source of externally supplied water at an opposite end;
and a handle on said housing for applying a downward force thereto;
whereby supplying said water under pressure rotates said drill bit to force said second end thereof through one of a wall, floor and ceiling surface while rotating said nozzle to spray a stream of water thereat in the extinguishment of a fire being present.

6. The apparatus of claim 5 wherein said rotatable spray nozzle includes a plurality of ports, individual ones of which are configured to spray water out from said housing

7. The apparatus of claim 5 wherein said rotatable spray nozzle includes a plurality of ports, individual ones of which are configured to spray water upwardly, downwardly, and outwardly out from said housing.

8. The apparatus of claim 7, also including means cooperating with said housing for securing said housing in place at said wall, floor and ceiling surface as said spray nozzle and drill bit rotate in response to the water being externally supplied via said fire hose.
